(19) United States
(12) Patent Application Publication
(10) Pub. No.: US 2003/0061359 A1
(43) Pub. Date: Mar. 27, 2003

(54) Distributed processing system

(75) Inventor: Tadashi Kimura, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/252,366

(22) Filed: Sep. 24, 2002

(30) Foreign Application Priority Data
Sep. 25, 2001 (JP) 2001-291893

(51) Int. Cl. G06F 15/16

(52) U.S. Cl. 709/227; 709/225

(57) ABSTRACT

A distributed processing system capable of informing a client terminal about servers to which sessions are set via a loadbalancer. In an LDAP directory service system in which a client terminal is connected to a directory server group including a plurality of directory servers via a loadbalancer, the client terminal comprises a session information storing section, a server information search means, and an output device. The session information storing section stores session numbers of sessions set between the client terminal and the respective servers via the loadbalancer. The server information search means searches for server identification numbers of servers to which the sessions are set using the stored session numbers as parameters, and outputs the server identification numbers with the corresponding session numbers as a search result. The output device is connected to the client terminal to display the search result obtained from the server information search means.

### BACKGROUND OF THE INVENTION

The present invention relates to a distributed processing system in which client terminals are connected to plural servers via a loadbalancer, and in particular, to a distributed processing system suitable for a directory service system controlled by the LDAP, in which the client terminals can obtain information about servers to which sessions are set through a loadbalancer.

### DESCRIPTION OF THE RELATED ART

Currently, a distributed processing system in which client terminals are connected to plural servers via a network becomes widely used. This kind of distributed processing system includes a directory service system controlled by the LDAP (Lightweight Directory Access Protocol).

The directory service system employs the LDAP as an access protocol, permitting users to gain access to user information and files distributed to the plural servers and to interact with the plural servers as if to log into a single server. The directory service system is used as, for example, an in-company directory service and a directory assistance service by a telephone company.

In this kind of distributed processing system such as the directory service system, a loadbalancer may be placed between client terminals and a plurality of directory servers in consideration of traffic loads on a network.

FIG. 1 is a block diagram showing a configuration of a conventional distributed processing system including such a loadbalancer.

As shown in FIG. 1, in the conventional distributed processing system, sessions are established between a directory server group 100 including a plurality of directory servers 101A, 101B, . . . , 101n and a plurality of client terminals 300 (300A, 300B, . . . , 300n) via a loadbalancer 200.

When there are plenty of accesses, requests, etc. from the client terminals 300 to the directory server group 100, the loadbalancer 200 takes account of access counts, amount of data transfer, states of respective servers, etc. in a comprehensive manner to distribute the requests to the servers 101A, 101B, . . . , 101n. Namely, the loadbalancer 200 is a load distributing device for balancing loads on the network by the distribution.

By the function of the loadbalancer 200, the client terminals select an optimum network with less traffic loads automatically to access at least one of the directory servers.

However, in the conventional distributed processing system with the loadbalancer, it is impossible on the side of the client terminals to know one server of all others to which a session is set.

In the distributed processing system with the loadbalancer, the client terminals specify an IP address of the loadbalancer, not IP addresses of the servers, to set sessions.

Thereby, the client terminals cannot have information about session-set servers (serves to which sessions are set). For example, when plenty of sessions are concentrated on one server, the client terminals cannot take such action as reset the sessions.

Since the client terminals cannot acquire information about the directory servers, as is obvious, it is also impossible to output and display information about session-set servers on displays of the client terminals to inform the users about the information. Consequently, it is completely impossible for the users to obtain information about the directory servers.

Incidentally, there has been disclosed in respective Japanese Patent Applications Laid-Open No. HEI8-44677 and No. HEI10-312365 a means to change servers connected to a client terminal according to a loaded state and a processing state of each server in a distributed processing system in which client terminals are connected to a plurality of servers.

However, the respective systems are not provided with loadbalancers, thereby failing to resolve problems inherent in a distributed processing system including a loadbalancer for distributing loads on a network.

That is, while a system provided with a loadbalancer between servers and clients is capable of distributing loads on a network, the system is incapable of distributing those on servers because the loadbalancer always gives priority to the loads on the network when executing distribution. This specific problem cannot be solved by the system without the loadbalancer.

### SUMMARY OF THE INVENTION

It is therefore an object of the present invention to provide a distributed processing system especially suitable for a directory service system employing LDAP, which comprises client terminals each having a search means (section), wherein when a client terminal has sessions with a plurality of servers via a loadbalancer, the search means of the client terminal searches for the servers using session numbers assigned to the sessions as parameters, thus enabling the user of the client terminal to know session-set or session partner servers despite the presence of the loadbalancer.

According to a first aspect of the present invention, for achieving the objects mentioned above, there is provided a distributed processing system in which at least one client terminal is connected to a plurality of servers via a loadbalancer, wherein

the client terminal includes:

a session information storing section for storing session numbers of sessions set between the client terminal and the servers via the loadbalancer; and

a server information search means for searching for, via the loadbalancer, servers to which the sessions are set using the session numbers stored in the session information storing section as parameters, and outputting a search result including identification numbers of found servers.

According to a second aspect of the present invention, in the first aspect, the server information search means outputs a search result including the identification numbers of the found servers along with corresponding session numbers.

According to the distributed processing system with this configuration, the client terminal stores the session numbers assigned to the sessions set between the client terminal and the servers via the loadbalancer, thus enabling the terminal to find servers to which the sessions are set using the session numbers as parameters.

By this means, on the side of the client terminal, it becomes possible to uninhibitedly search for servers in sessions that the client terminal logs into. In addition, in the distributed processing system with the loadbalancer, it becomes possible to identify servers to which the sessions are set without storing, retaining, etc. IP addresses of the respective servers on the side of the user terminal. Therefore, it becomes possible for the user of the client terminal to arbitrarily reset, reestablish and the like the sessions based on the acquired server information.

According to a third aspect of the present invention, in the first or second aspect, the client terminal includes an environment variable storing section for storing all identification numbers of the plurality of servers connected to the client terminal, and the server information search means outputs a search result including the all identification numbers stored in the environment variable storing section in addition to the identification numbers of the found servers.

According to the distributed processing system with this configuration, the client terminal retains the identification numbers of all servers that the client terminal might log into to set sessions. Thereby, it becomes possible to search for information about all servers, which includes information about whether or not the sessions are set to the respective servers, and to output the information.

By this means, it becomes possible for the user of the client terminal to obtain useful server information including not only servers to which the sessions are set but also servers to which the sessions are not set, thus enabling effective selection and execution of processing such as reset for the sessions, and the like.

According to a fourth aspect of the present invention, in one of the first through third aspects, the client terminal includes a server information storing section for storing the search result obtained by the server information search means.

According to the distributed processing system with this configuration, by including the storing section for storing the search information (result), it becomes possible for the user to check, use, modify, etc. the search result as needed, thus enabling a distributed processing system with higher convenience to be provided.

According to a fifth aspect of the present invention, in one of the first through fourth aspects, the distributed processing system further includes an output device connected to the client terminal for displaying the search result obtained by the server information search means.

According to the distributed processing system with this configuration, by including the output device such as a display, etc. for displaying the search result, it becomes possible for the user to check out the server information at any time on the display screen, etc., thus realizing a distributed processing system with higher convenience.

According to a sixth aspect of the present invention, in one of the first through fifth aspects, the distributed processing system is controlled by a lightweight directory access protocol.

By this means, the distributed processing system according to the present invention can be adopted as a directory service system controlled by the LDAP and the like.

### BRIEF DESCRIPTION OF THE DRAWINGS

The objects and features of the present invention will become more apparent from the consideration of the following detailed description taken in conjunction with the accompanying drawings in which:

FIG. 1 is a block diagram showing a configuration of a conventional distributed processing system;

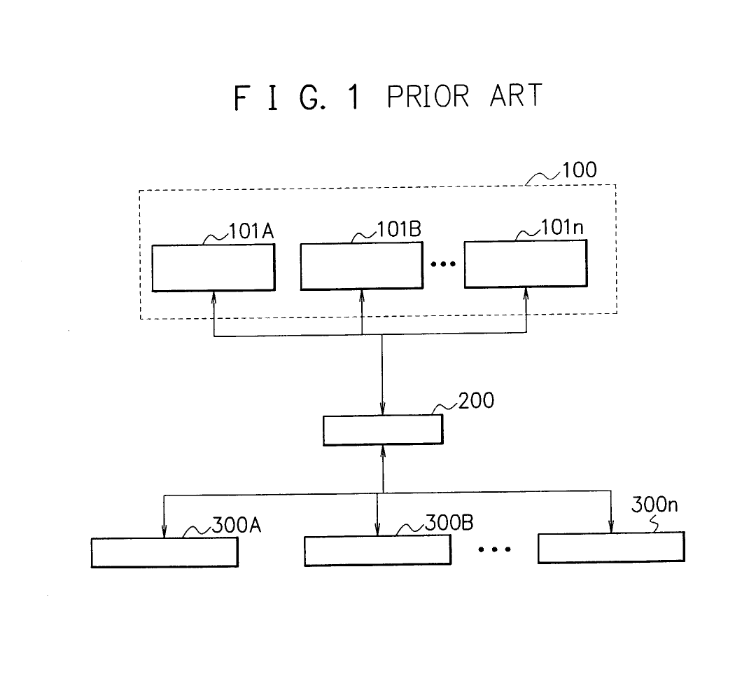

FIG. 2 is a block diagram showing a configuration of a distributed processing system according to a first embodiment of the present invention;

FIG. 3 is a flowchart showing operation of the distributed processing system shown in FIG. 2;

FIG. 4 is a block diagram showing a configuration of a distributed processing system according to a second embodiment of the present invention; and

FIG. 5 is a flowchart showing operation of the distributed processing system shown in FIG. 4.

### DESCRIPTION OF THE PREFERRED EMBODIMENTS

Referring now to the drawings, embodiments of the present invention are explained in detail.

Incidentally, a distributed processing system according to the following embodiments may be implemented by a computer controlled by a program.

The computer may load the program from, for example, a recording medium directly inserted in a drive thereof, or download the program from a host or a remote computer through a communication line.

Examples of the recording medium include a magnetic disk, a semiconductor memory, and any other recording medium readable by the computer.

[First Embodiment]

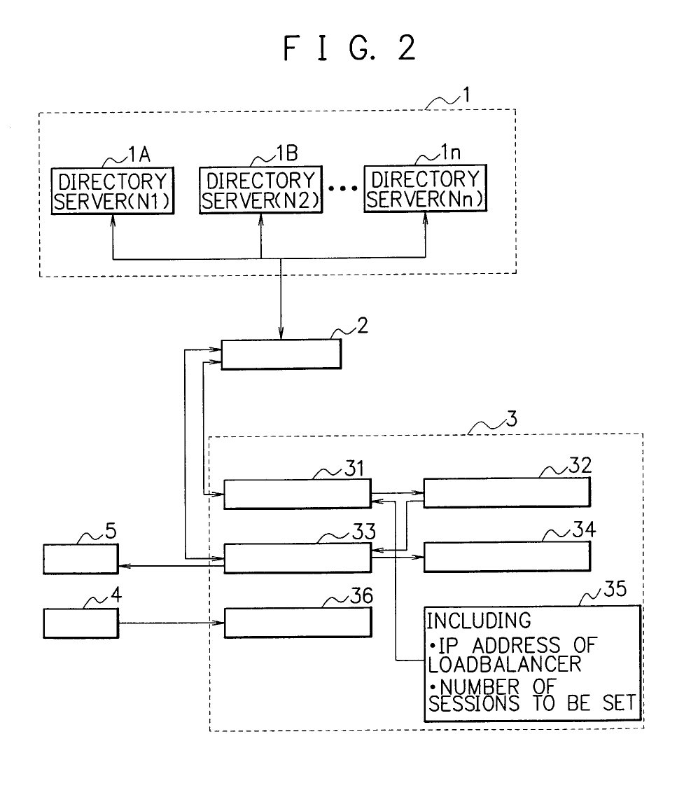

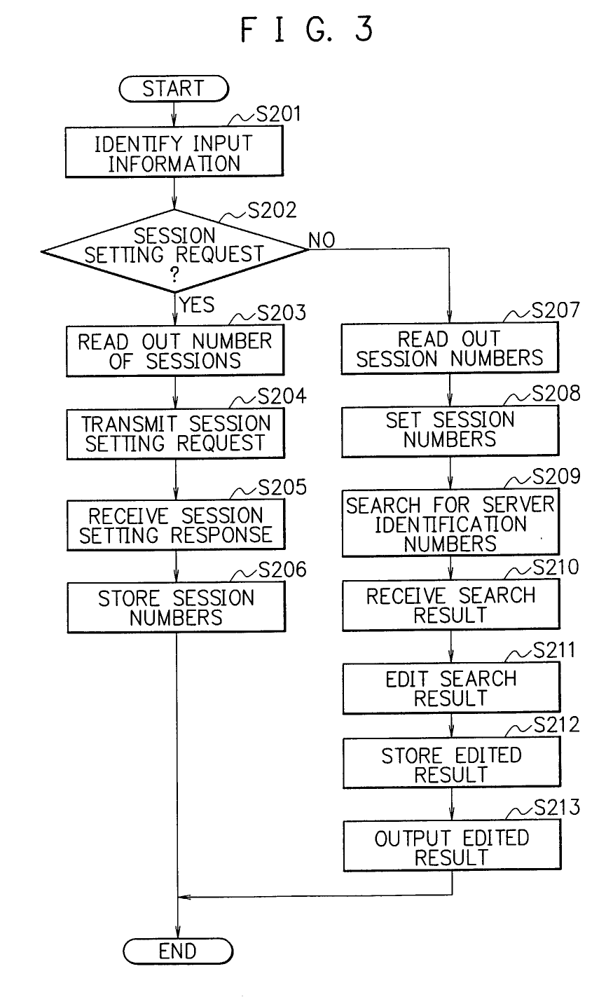

An explanation is given of a distributed processing system according to the first embodiment of the present invention in reference to FIGS. 2 and 3.

FIG. 2 is a block diagram showing a configuration of the distributed processing system according to the first embodiment of the present invention.

FIG. 3 is a flowchart showing operation of the distributed processing system shown in FIG. 2.

First, an explanation is given of a basic configuration of the distributed processing system according to this embodiment.

In this embodiment, the distributed processing system is used as a directory service system controlled by the LDAP (Lightweight Directory Access Protocol).

The directory service system is a distributed processing system capable of gaining access to user information and files distributed to a plurality of directory servers and interacting with the plural servers, etc. as if to log into a single server, employing the LDAP as an access protocol.

To be concrete, the distributed processing system comprises a directory server group 1, a loadbalancer 2, and a client terminal 3. The directory server group 1 is composed of a plurality of directory servers 1A, 1B, . . . , 1n. The loadbalancer 2 determines directory servers to have sessions with the client terminal 3 according to traffic loads on a network. The client terminal 3 operates by a program.

The directory server group 1 includes a plurality of directory servers (the directory servers 1A, 1B, . . . , 1n shown in FIG. 2) such as PCs, UNIX servers, etc., each of which executes predetermined processes such as outputting data retained in a database server, permitting the use of peripherals such as a printer, and the like in response to accesses and requests from the client terminal 3.

The loadbalancer 2 is a load distributing device that takes account of access counts, amount of data transfer, states of respective servers, etc. in a comprehensive manner when there are plenty of accesses, requests, etc. from the client terminal(s) 3 to the directory server group 1 to distribute the requests, etc. to the plurality of servers 1A, 1B, . . . , 1n, thus lightening the loads on a server or balancing the loads on a network.

The client terminal 3 is a user terminal such as PC that is connected to the directory server group 1 and has access thereto via the loadbalancer 2, which is capable of retrieving predetermined data stored in the directory servers, for example.

To the client terminal 3, there are connected an input device 4 such as a keyboard, a pointing device, etc. and an output device 5 such as a display, a printer, etc.

In this embodiment, an LDAP session setting (establishing) request and a server information search request are inputted through the input device 4, and a server information search result is outputted and displayed through the output device 5.

Incidentally, while in FIG. 2 only one client terminal 3 is illustrated for simplicity, a plurality of client terminals 3 having the same configuration may be connected to the directory server group 1 via the loadbalancer 2.

Moreover, the client terminal 3 according to this embodiment includes a session setting means (section) 31, a session information storing section 32, a server information search means (section) 33, a server information storing section 34, an environment variable storing section 35, and an input information identifying means (section) 36.

The session setting means 31 reads an IP address of the loadbalancer 2 and the number of sessions to be set, which are stored in the environment variable storing section 35 beforehand, to transmit an LDAP session setting request to the loadbalancer 2.

Moreover, when receiving an LDAP session setting response from the loadbalancer 2, the session setting means 31 outputs session numbers of the set (established) sessions to the session information storing section 32.

The session information storing section 32 stores the session numbers inputted from the session setting means 31.

Incidentally, the “LDAP session” indicates a logical line established between the directory server and the client terminal in accordance with the LDAP protocol, and the “number of sessions” represents the number of the logical lines. Incidentally, at least one session may be set (established) per client terminal.

When the “LDAP sessions are set”, sessions are established (namely, the client terminal 3 logs into the directory servers) after bind processing has succeeded.

Execution of the bind processing to the directory servers is referred to as the “transmission of the LDAP session setting request”. To be concrete, the term represents transmission of data for bind processing from the client terminal to the directory server.

The “session number” indicates a specific number assigned to the respective established sessions by control software of the LDAP when the bind processing has succeeded.

The server information search means 33 reads the session numbers out of the session information storing section 32 to search for server identification numbers via the loadbalancer 2 using the session numbers as parameters.

Moreover, when receiving a search result via the loadbalancer 2, the server information search means 33 edits the search result using the server identification numbers and the session numbers in such manner as to associate a server identification number with a corresponding session number. Subsequently, the search means 33 outputs the edited data to the server information storing section 34 to have the storing means 34 store the edited data, and also outputs the data to the output device 5 connected to the client terminal 3.

The server information storing section 34 stores the search result (edited data) inputted from the server information search means 33.

The environment variable storing section 35 stores in advance the IP address of the loadbalancer 2 and the number of sessions to be set (established) on the system.

The input information identifying means 36 identifies a request input from the input device 4 connected to the client terminal 3. To be concrete, the identifying means 36 determines whether the input request is the LDAP session setting request or the server information search request. Subsequently, according to the identified input request, the identifying means 36 starts up the session setting means 31 or the server information search means 33.

In the following, an explanation is given of basic operation of the distributed processing system according to this embodiment.

First, when predetermined input operation is executed through the input device 4 connected to the client terminal 3, the input information identifying means 36 identifies whether the input request is the LDAP session setting request or the server information search request.

In the case where the input request is the LDAP session setting request, the input information identifying means 36 activates the session setting means 31.

The session setting means 31 reads the IP address of the loadbalancer 2 and the number of sessions to be set out of the environment variable storing section 35, and transmits the LDAP session setting requests corresponding to the number of sessions to the directory server group 1 (namely, the setting means 31 transmits the LDAP session setting request the same number of times as the number of sessions).

Hereat, the transmission of the LDAP session setting request means transmission of data for bind processing based on the LDAP protocol from the client terminal 3 to the directory server group 1.

When the LDAP session setting request is transmitted, the loadbalancer 2 selects certain directory servers 1A, 1B, . . . , and/or 1n from the directory server group 1, and transfers the LDAP session setting requests to the selected directory servers.

Hereat, the loadbalancer 2 takes account of access counts on the network, the amount of data transfer, the states of respective servers, etc. in a comprehensive manner to select the servers 1A, 1B, . . . , and/or 1n to which the sessions are to be set.

Subsequently, bind processing based on the LDAP protocol is executed between the selected directory servers 1A, 1B, . . . , and/or 1n and the client terminal 3, thus setting (establishing) the LDAP sessions therebetween.

After the LDAP sessions are set up, unique session numbers are assigned to the respective sessions under the control of the LDAP, and the LDAP session setting response is transmitted to the client terminal 3. The setting response is received by the session setting means 31.

When receiving the LDAP session setting response, the session setting means 31 outputs the session numbers included in the response to the session information storing section 32. Subsequently the session numbers are stored in the storing section 32.

On the other hand, in the case where the input request is the server information search request, the input information identifying means 36 activates the server information search means 33.

The server information search means 33 reads the session numbers out of the session information storing section 32 to search for server information about the directory servers to which the LDAP sessions are set. Subsequently, the search means 33 sets the session numbers up as the parameters to search for server identification numbers.

When receiving a search result, the server information search means 33 edits the search result using the server identification numbers and the session numbers in such manner as to associate a server identification number with a relevant session numbers, and outputs the edited result to the server information storing section 34 and the output device 5. The edited result is stored in the storing section 34.

Accordingly, a user at the client terminal 3 can check out the server information on a display, etc. of the output device 5 to obtain information about the directory servers to which the LDAP sessions are set. Thereby, it becomes possible to reset (reestablish the sessions and the like) the sessions if required.

Incidentally, the distributed processing system according to this embodiment comprises the output device 5 for displaying the search result, thus enabling the user to confirm the directory server information on the screen of the display, etc. at any time.

Moreover, according to this embodiment, the server information storing section 34 stores the search information, thus enabling the user at the client terminal 3 to confirm, use, modify, etc. the search result at pleasure or as needed.

In the following, an explanation is given of an example of operation in detail in the distributed processing system according to this embodiment configured as described above referring to the flowchart in FIG. 3.

Incidentally, in the following example of operation, the number of session settings stored in the environment variable storing section 35 in the client terminal 3 is “2”, and the loadbalancer 2 selects the directory servers 1A and 1B from the directory server group 1 at the time of the LDAP session setting.

Moreover, the session number “S1” is set to the session with the directory server 1A, and the session number “S2” is with the directory server 1B.

Furthermore, the server identification number “N1” is set to the directory server 1A, and the server identification number “N2” is to the directory server 1B.

First, when there is an input from the input device 4, the input information identifying means 36 identifies the input information (Step S201).

When the input is the LDAP session setting request (Step S202/YES), the input information identifying means 36 activates the session setting means 31.

The activated session setting means 31 reads the number of the LDAP sessions to be set, “2”, out of the environment variable storing section 35 (Step S203), and transmits the LDAP session setting request “two times” to the loadbalancer 2 (Step S204).

When the LDAP session setting request is transmitted predetermined times, the LDAP sessions are set to the respective directory servers 1A and 1B in the directory server group 1 via the loadbalancer 2, and the LDAP session setting response is returned.

When the LDAP session setting response is received by the session setting means 31 (Step S205), the session numbers “S1” and “S2” assigned to the sessions to the directory servers 1A and 1B, respectively, are stored in the session information storing section 32 (Step S206).

Subsequently, when the server information search request is inputted, the input information identifying means 36 identifies that the input is the server information search request (Steps S201 and S202/NO), and activates the server information search means 33.

The server information search means 33 reads out the session numbers “S1” and “S2” stored in the session information storing means 32 (Step S207), sets the session numbers “S1” and “S2” as the parameters for the server information search request (Step S208), and searches for the server identification information (numbers) (Step S209).

As a result of the search, the server information search means 33 receives the server identification numbers “N1” and “N2” from the directory servers 1A and 1B, respectively (Step S210).

The server information search means 33 edits the search result using the server identification numbers and the session numbers in such manner as to associate the server identification numbers “N1” and “N2” with the session numbers “S1” and “S2”, respectively, (Step S211), outputs the edited result to the server information storing section 34, the edited result being stored in the storing means 34 (Step S212), and outputs the edited result to the output device 5 (Step S213).

At this point, it becomes possible for the user at the client terminal 3 to confirm which session is established to which server on the display, etc. of the output device 5.

As explained hereinbefore, according to the distributed processing system in this embodiment, on the side of the client terminal 3, the session numbers assigned to the sessions set between the client terminal 3 and the directory server group 1, which are connected via the loadbalancer 2, can be stored and used as the parameters to search for the servers to which the sessions are set.

Consequently, on the side of the client terminal 3, it becomes possible to uninhibitedly search for the directory servers in the LDAP sessions. Furthermore, in the distributed processing system in which the directory servers are connected to the client terminal 3 via the loadbalancer 2, on the side of the client terminal 3, it becomes possible to identify the directory servers to which the LDAP sessions are set without storage, retention, etc. of IP addresses of the respective servers.

Accordingly, it becomes possible to arbitrarily reset, etc. the LDAP sessions based on the acquired directory server information on the side of the client terminal 3.

[Second Embodiment]

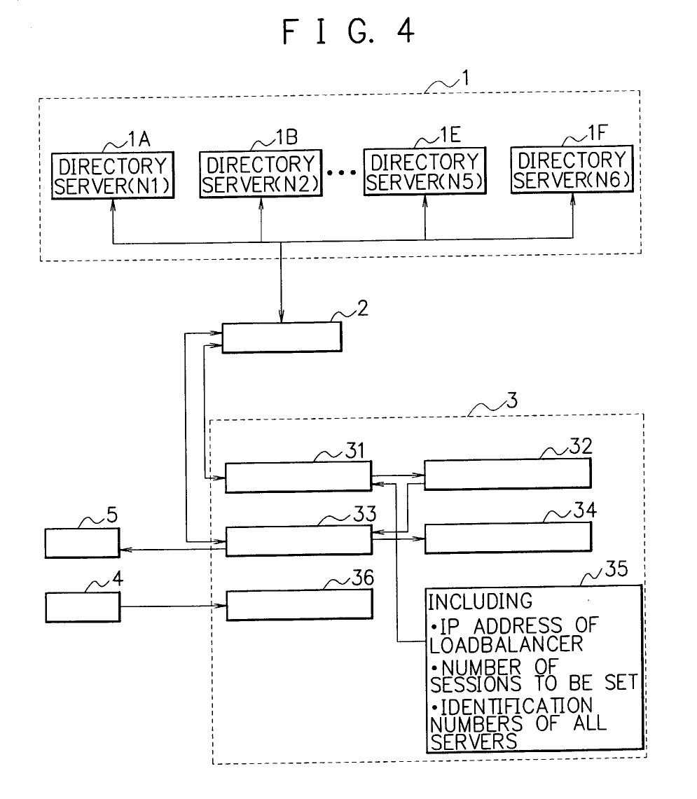

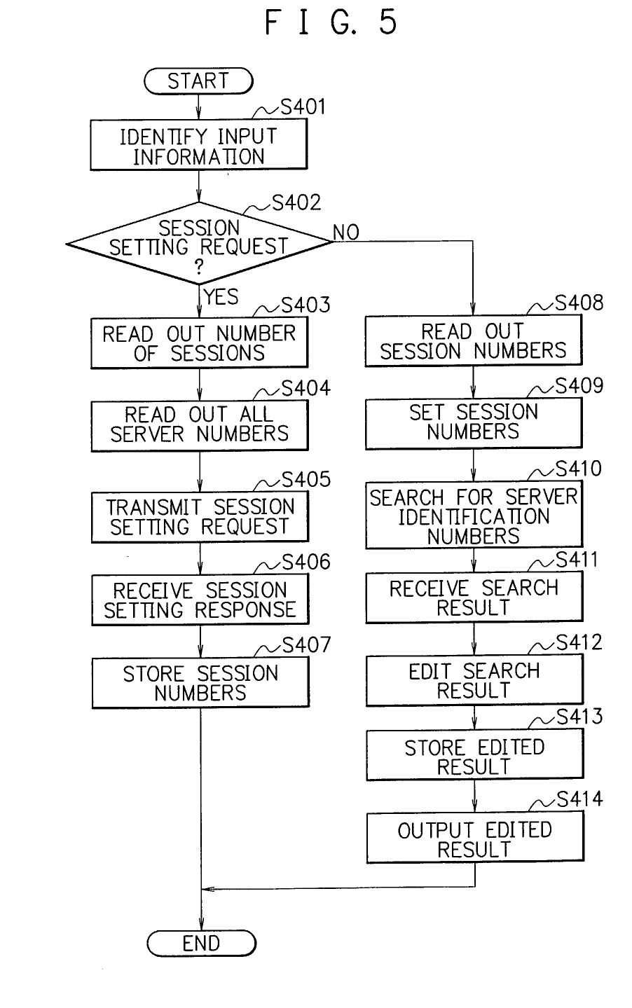

In the following, an explanation is given of a distributed processing system according to the second embodiment of the present invention in reference to FIGS. 4 and 5.

FIG. 4 is a block diagram showing a configuration of the distributed processing system according to the second embodiment of the present invention.

FIG. 5 is a flowchart showing operation of the distributed processing system shown in FIG. 4 according to this embodiment.

The distributed processing system according to this embodiment is a modification of the first embodiment described above. That is, the environment variable storing section 35 stores all the server identification numbers for the directory servers connected to the client terminals 3. Therefore, it becomes possible to display, with respect to each directory server, a search result including LDAP session status (whether or not the LDAP session is set) and the session numbers assigned to the sessions, which is obtained on the basis of the session numbers, on the display or the like of the output device 5.

Accordingly, except for the environment variable storing section 35, the configuration of the second embodiment is the same as that of the first embodiment, thereby abbreviating the detailed explanation in regard to the identical sections. Incidentally, in FIG. 4, the same sections are denoted by the same reference numbers as in FIG. 2.

As shown in FIG. 4, in the distributed processing system according to this embodiment, the environment variable storing section 35 stores and retains in advance the IP address of the loadbalancer 2, the number of sessions to be set on the system, and the server identification numbers of all the directory servers included in the directory server group 1.

All of the server identification numbers stored in the environment variable storing section 35 is read out by the session setting means 31, and used for a search result edited by the server information search means 33.

To be concrete, when the session setting request is input from the input device 4, the session setting means 31 reads the number of sessions to be set (established), the IP address of the loadbalancer 2, and the server identification numbers of all the directory servers out of the environment variable storing section 35.

In addition, the session setting means 31 transmits the LDAP session setting requests corresponding to the read out number of sessions to the loadbalancer 2.

The server information search means 33 searches for the server identification numbers of the directory servers in the same manner as described in the first embodiment.

Subsequently, when receiving the search result from the directory servers, the server information search means 33 associates the found server identification numbers with the session numbers, which is to be outputted as a search result. At this point, in regard to the non-session-set directory servers, the search means 33 displays an item of its session number as “not connected”, etc., which is also to be outputted as a search result.

The edited result is outputted to the server information storing section 34 to have the storing section 34 store the edited result, and outputted also to the output device 5 as with the first embodiment.

By this means, on a display, etc. of the output device 5 of the client terminal 3, there are displayed the server identification numbers of all the directory servers (1A to 1F shown in FIG. 4), and the search result on session-number basis including the LDAP session status and the session numbers assigned to the sessions with respect to each directory server.

In the following, an explanation is given of an example of concrete operation in the distributed processing system according to this embodiment configured as described above referring to the flowchart in FIG. 5.

Incidentally in the following explanation, the number of session settings stored in the environment variable storing section 35 in the client terminal 3 is “5”, and the loadbalancer 2 selects the directory servers 1A, 1B, 1C, 1D and 1E from the directory server group 1 (including the directory servers 1A to 1F) at the time of the LDAP session setting. In other words, in the example of the operation, the LDAP session is not established between the client terminal 3 and the directory server 1F.

Besides, the session numbers “S1”, “S2”, “S3”, “S4” and “S5” are assigned to the sessions to the directory servers 1A, 1B, 1C, 1D and 1E, respectively.

Further, the server identification numbers “N1”, “N2”, “N3”, “N4”, “N5” and “N6” are set to the directory servers 1A through 1F all included in the directory server group 1, respectively.

First, when there is an input from the input device 4, the input information identifying means 36 identifies the input information (Step S401).

In the case where the input is the LDAP session setting request (Step S402/YES), the input information identifying means 36 activates the session setting means 31. When activated, the session setting means 31 reads the number of the LDAP sessions to be established, “5”, out of the environment variable storing section 35 (Step S403), and reads out the server identification numbers “N1” through “N6” of all the directory servers (Step S404).

Subsequently, the session setting means 31 transmits the LDAP session setting request “five times” to the loadbalancer 2 (Step S405).

When the LDAP session setting request is transmitted predetermined times, the LDAP sessions are set between the client terminal 3 and the directory servers 1A through 1E, respectively, included in the directory server group 1, and the LDAP session setting response(s) is returned.

When the LDAP session setting response is received by the session setting means 31 (Step S406), the session numbers “S1” through “S5” assigned to the sessions to the directory servers 1A through 1E, respectively, are stored in the session information storing section 32 (Step S407).

Subsequently, when the server information search request is input, the server information identifying means 36 identifies the input as it is (Steps S401 and S402/NO), and activates the server information search means 33.

The server information search means 33 reads out the session numbers “S1” through “S5” stored in the session information storing section 32 (Step S408), sets the numbers “S1” through “S5” as parameters for server information search request (Step S409), and searches for the server identification information (numbers) (Step S410).

As a result of the search, the server information search means 33 receives the server identification numbers “N1”, “N2”, “N3”, “N4” and “N5” from the directory servers “1A”, “1B”, “1C”, “1D” and “1E”, respectively (Step S411).

The server information search means 33 edits the search result using the identification numbers and the session numbers in such manner as to associate the server identification numbers “N1” through “N5” with the corresponding session numbers “S1” through “S5”, respectively (Step S412).

Incidentally, in regard to the directory server 1F (refer to FIG. 4) unfound in the search based on the session numbers, a display item for its server identification number “N6” is set and edited as “not connected”.

Subsequently, the edited result is stored in the server information storing section 34 (Step S413), and outputted to the output device 5 (Step S414).

At this point, it becomes possible for the user at the client terminal 3 to confirm which session is established to which directory server through a display, etc. of the output device 5.

In addition, on the display, etc. of the output device 5, in regard to the directory servers 1A through 1E to which the LDAP sessions are set, the server identification numbers (“N1” through “N5”) and the session numbers (“S1” through “S5”) are edited and displayed so as to associated with each other, respectively. On the other hand, in regard to the directory server 1F to which the LDAP session is not set, there is displayed a kind of a term of “not connected” along with the server identification number (“N6”) on the display thereof.

As explained hereinbefore, according to the distributed processing system in this embodiment, the environment variable storing means 35 in the client terminal 3 retains the server identification numbers of all the directory servers to which the LDAP sessions might be set, thereby enabling search and output of all the directory server information and information of whether or not the LDAP session is now set with respect to each directory server.

Accordingly, on the side of the client terminal 3, it becomes possible to obtain useful server information about not only the directory servers to which the LDAP sessions are set but also the directory servers to which the LDAP sessions are not set, thus enabling effective change of servers to be connected and efficient processing of reset for the servers, etc.

Incidentally, the distributed processing system in the present invention will not be limited to the above configurations, and includes the modified and amended configurations that can be obtained by those skilled in the art within the scopes of the claims of the present invention.

For example, while in the above explanation the LDAP directory service system employing the LDAP as its protocol is taken as an example, it will not be limited to the LDAP.

That is, the present invention is applied to a case where client terminals are connected to plural servers via a loadbalancer, and is intended to acquire server information about servers to which sessions are set or established on the side of the client terminals. Thereby, as long as the client terminals are connected to the plural servers via the loadbalancer, the present invention may be applied to any system under various protocols.

As set forth hereinbefore, according to the present invention, when the client terminal is connected to the plurality of servers via the loadbalancer, the client terminal is provided with the search means to search for servers to which sessions are set or established using the session numbers assigned to the sessions set between the client terminal and the servers as parameters. Thereby, it becomes possible to acquire the servers to which the sessions are set on the client terminal's side even through the loadbalancer. Accordingly, on the side of the client terminals, it becomes possible to reset and the like the set sessions. It is especially preferable to apply the present invention to a directory service system controlled by the LDAP.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A distributed processing system in which at least one client terminal is connected to a plurality of servers via a loadbalancer, wherein
the client terminal includes:
a session information storing section for storing session numbers of sessions set between the client terminal and the servers via the loadbalancer; and
a server information search section for searching for, via the loadbalancer, servers to which the sessions are set using the session numbers stored in the session information storing section as parameters, and outputting a search result including identification numbers of found servers.

2. A distributed processing system in which at least one client terminal is connected to a plurality of servers via a loadbalancer, wherein
the client terminal includes:
a session information storing section for storing session numbers of sessions set between the client terminal and the servers via the loadbalancer;
a server information search section for searching for, via the loadbalancer, servers to which the sessions are set using the session numbers stored in the session information storing section as parameters, and outputting a search result including identification numbers of found servers; and
an environment variable storing section for storing all identification numbers of the plurality of servers connected to the client terminal, wherein:
the server information search section outputs a search result including the all identification numbers stored in the environment variable storing section in addition to the identification numbers of the found servers.

3. A distributed processing system in which at least one client terminal is connected to a plurality of servers via a loadbalancer, wherein
the client terminal includes:
a session information storing section for storing session numbers of sessions set between the client terminal and the servers via the loadbalancer;
a server information search section for searching for, via the loadbalancer, servers to which the sessions are set using the session numbers stored in the session information storing section as parameters, and outputting a search result including identification numbers of found servers; and
a server information storing section for storing the search result obtained by the server information search section.

4. A distributed processing system in which at least one client terminal is connected to a plurality of servers via a loadbalancer, wherein
the client terminal includes:
a session information storing section for storing session numbers of sessions set between the client terminal and the servers via the loadbalancer;
a server information search section for searching for, via the loadbalancer, servers to which the sessions are set using the session numbers stored in the session information storing section as parameters, and outputting a search result including identification numbers of found servers;
an environment variable storing section for storing all identification numbers of the plurality of servers connected to the client terminal; and
a server information storing section for storing the search result obtained by the server information search section, wherein:
the server information search section outputs a search result including the all identification numbers stored in the environment variable storing section in addition to the identification numbers of the found servers.

5. The distributed processing system as claimed in claim 1, wherein the server information search section outputs a search result including the identification numbers of the found servers along with corresponding session numbers.

6. The distributed processing system as claimed in claim 2, wherein the server information search section outputs a search result including the identification numbers of the found servers along with corresponding session numbers.

7. The distributed processing system as claimed in claim 3, wherein the server information search section outputs a search result including the identification numbers of the found servers along with corresponding session numbers.

8. The distributed processing system as claimed in claim 4, wherein the server information search section outputs a search result including the identification numbers of the found servers along with corresponding session numbers.

9. The distributed processing system as claimed in claim 1, including an output device connected to the client terminal for displaying the search result obtained by the server information search section.

10. The distributed processing system as claimed in claim 2, including an output device connected to the client terminal for displaying the search result obtained by the server information search section.

11. The distributed processing system as claimed in claim 3, including an output device connected to the client terminal for displaying the search result obtained by the server information search section.

12. The distributed processing system as claimed in claim 4, including an output device connected to the client terminal for displaying the search result obtained by the server information search section.

13. The distributed processing system as claimed in claim 1, wherein the distributed processing system is controlled by a lightweight directory access protocol.

14. The distributed processing system as claimed in claim 2, wherein the distributed processing system is controlled by a lightweight directory access protocol.

15. The distributed processing system as claimed in claim 3, wherein the distributed processing system is controlled by a lightweight directory access protocol.

16. The distributed processing system as claimed in claim 4, wherein the distributed processing system is controlled by a lightweight directory access protocol.
